(19) United States
(12) Patent Application Publication
(10) Pub. No.: US 2015/0039370 A1
(43) Pub. Date: Feb. 5, 2015

(54) SYSTEMS AND METHODS FOR COMMUNICATING SCHEDULING DATA

(71) Applicant: DiningCircle, LLC, Clayton, MO (US)

(72) Inventor: Anthony Favazza, University City, MO (US)

(21) Appl. No.: 14/448,605

(22) Filed: Jul. 31, 2014

Related U.S. Application Data
(60) Provisional application No. 61/861,175, filed on Aug. 1, 2013.

(51) Int. Cl. G06Q 10/10

(52) U.S. Cl. CPC G06Q 10/1095
USPC 705/7.19

(57) ABSTRACT

A method or system for communicating scheduling data to a user is disclosed herein. The scheduling system may have an automatic “switch.” The switch changes a default, or adds a supplementary, appointment communication method during periods of high demand on the user's attention. For example, a restaurant reservation system may normally communicate reservations via e-mail until a shift occurs. Then the system switches to communicating new reservation information relevant to that shift additionally or alternatively by telephone. Telephone messages may be more preferred and easily handled by the restaurant staff while working the busy shift. Non-relevant reservation information (e.g., reservations falling outside the shift time block) may continue to be communicated by the default e-mail method. The switch may also be triggered by an event, such as by issuance of a consolidated shift report including all the reservations in a shift.

### RELATED APPLICATION

This application is a non provisional application claiming priority to U.S. Provisional Patent No. 61/861,175, entitled “A Method for Communicating Scheduling Data”, filed Aug. 1, 2013, the content of which is herein incorporated by reference in its entirety.

### TECHNICAL FIELD

The subject matter disclosed herein generally relates to scheduling methods and software such as online reservation and scheduling systems.

### BACKGROUND

Restaurants, and other service businesses, are increasingly using electronic communications to handle reservations and other appointments. For example, the OPENTABLE website allows a diner to log on, search for a restaurant, enter a reservation date, time and number of attendees, and select amongst open slots to reserve a table at the restaurant. Once the reservation is booked, the OPENTABLE software communicates the reservation to the restaurant. The reservations are then handled by the restaurant workers as the diners arrive at or around their reservation times.

Although the reservations are communicated by the software in a tidy manner, the process filling the reservations at the restaurant is very dynamic. The restaurant may take walkups, and they must be fit in with existing reservations. Also, the reservations themselves are often cancelled or modified in person and electronically. And, new reservations continue to be made and communicated electronically. It is especially difficult to reconcile electronic communications and live, in-person communications during a busy shift, such as lunch or dinner. Diners can be irritated by the perception of restaurant personnel being more focused on electronic communications than actual people standing in front of them.

Busy times and electronic reservation systems are not the purview of restaurants alone. Other service businesses, such as car repair, medical care, hair salons, etc., have to juggle high demand times with electronic reservations.

It would be advantageous for service businesses to have a way of more efficiently handling reservation changes, cancellations and new reservations that occur during periods of high service demand.

### SUMMARY

A method, system, and computer program product for communicating scheduling data to a user is disclosed herein. For example, the invention may include a scheduling system that has an automatic “switch.” The switch changes a default, or adds a supplementary, appointment communication method during periods of high demand on the user's attention. For example, a restaurant reservation system may normally communicate reservations via e-mail until a shift occurs. A shift may be a meal time, such as breakfast, lunch or dinner. Then the system switches to communicating new reservation information relevant to that shift additionally or alternatively by telephone. Telephone messages may be more preferred and easily handled by the restaurant staff while working the busy shift. Non-relevant reservation information (e.g., reservations falling outside the present shift time) may continue to be communicated by the default e-mail method. The switch may also be triggered by an event, such as by issuance of a consolidated shift report including all the reservations in an upcoming or current shift. Various implementations of the invention are especially useful for scheduling systems that rely on a combination of paper and electronic records for administering appointments.

According to certain implementations, a method of communicating scheduling data to a user includes: (1) electronically receiving a pre-selected time criteria from a user; (2) electronically receiving scheduling data associated with each of a plurality of appointments, the scheduling data associated with each appointment comprising at least one time of day; (3) electronically communicating the scheduling data to the user using a default communication mode; (4) identifying a relevant subset of the scheduling data that meets the pre-selected time criteria; (5) after identifying the relevant subset of the scheduling data, receiving new scheduling data; (6) parsing the new scheduling data into at least a relevant subset of new scheduling data and non-relevant subset of new scheduling data based on the pre-selected time criteria, the relevant subset of new scheduling data including new scheduling data that meets the pre-selected time criteria, and the non-relevant subset of new scheduling data including new scheduling data that does not meet the pre-selected time criteria; and (7) electronically communicating the relevant subset of the new scheduling data to the user using a second communication mode, wherein the second communication mode is different from the default communication mode.

In other implementations, a system for communicating scheduling data to the user is disclosed. The system includes a computing device that comprises a processor and a memory, and the processor is configured for: (1) electronically receiving a pre-selected time criteria from a user; (2) electronically receiving scheduling data associated with an appointment, the scheduling data for the appointment being associated with a first time at which the scheduling data is received and comprising a second time at which the appointment is to occur, the second time being subsequent to the first time; (3) comparing the first time and the second time with the pre-selected time criteria; (4) in response to the first time or the second time not meeting the pre-selected time criteria, communicating the scheduling data associated with the appointment to the user via the default communication mode; and (5) in response to the first time and the second time meeting the pre-selected time criteria, communicating the scheduling data associated with the appointment to the user via a second communication mode, wherein the second communication mode is different from the default communication mode.

### BRIEF DESCRIPTION OF THE DRAWINGS

The accompanying figures, which are incorporated in and constitute a part of this specification, illustrate several aspects described below.

FIG. 1 is a schematic of a scheduling data communication system according to one implementation.

FIG. 2 is a flow chart of a scheduling data communication method according to one implementation.

FIGS. 3-5 are exemplary graphical user interfaces configured for receiving reservation data from a prospective diner communicating with the system of FIG. 1 according to one implementation.

FIG. 6 is an exemplary email generated by the system of FIG. 1 of a reservation communicated to a restaurant according to one implementation.

FIG. 7 is an exemplary email generated by the system of FIG. 1 and communicated to a diner confirming a reservation by the diner according to one implementation.

FIG. 8 is an exemplary email generated by the system of FIG. 1 and communicated to a restaurant of a consolidated shift summary report according to one implementation.

FIG. 9 is a schematic of a central server according to one implementation.

Like reference numbers and designations in the various drawings indicate like elements.

### DETAILED DESCRIPTION

A method, system, and computer program product for communicating scheduling data to a user is disclosed herein. For example, the invention may include a scheduling system that has an automatic “switch.” The switch changes a default, or adds a supplementary, appointment communication method during periods of high demand on the user's attention. For example, a restaurant reservation system may normally communicate reservations via e-mail until a shift occurs. A shift may be a meal time, such as breakfast, lunch or dinner. Then the system switches to communicating new reservation information relevant to that shift additionally or alternatively by telephone. Telephone messages may be more preferred and easily handled by the restaurant staff while working the busy shift. Non-relevant reservation information (e.g., reservations falling outside the present shift time) may continue to be communicated by the default e-mail method. The switch may also be triggered by an event, such as by issuance of a consolidated shift report including all the reservations in an upcoming or current shift. Various implementations of the invention are especially useful for scheduling systems that rely on a combination of paper and electronic records for administering appointments.

The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

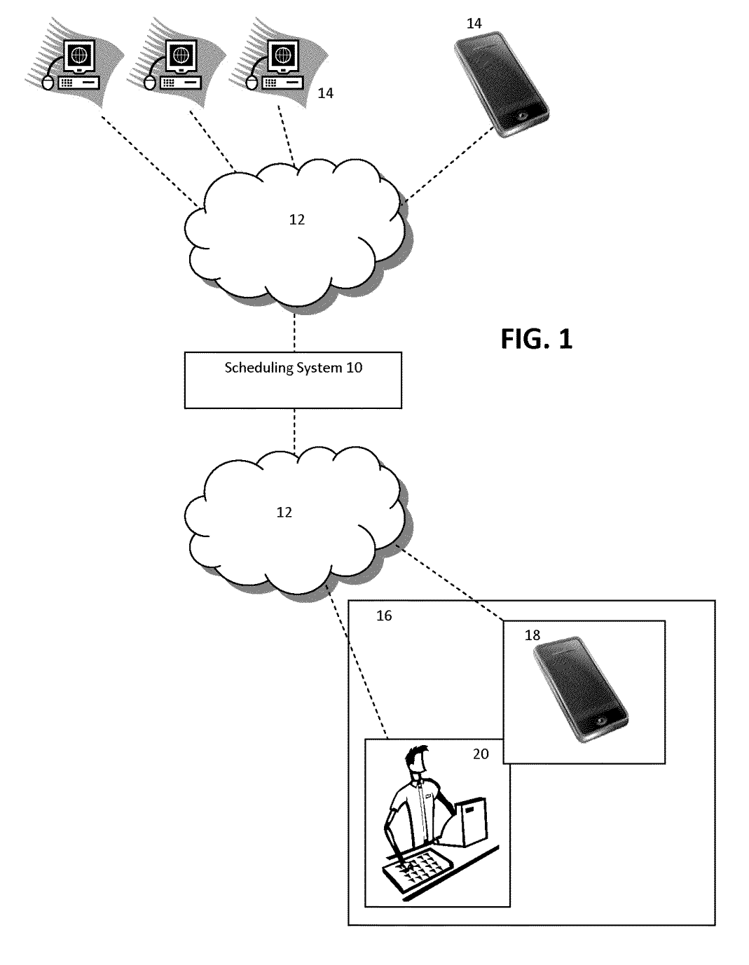

FIG. 1 shows a diagram of a scheduling system 10 according to one implementation. The scheduling system 10 is in electronic communication, for example, via an electronic communications network 12 (such as the internet) with computing devices associated with a plurality of customers (or clients) 14 making appointments and/or changes to existing appointments. The scheduling system 10 is also in electronic communication with computing devices associated with one or more users 16, such as restaurants, doctor's offices, hair salons, or other service providers, who receive and handle the appointments. For example, the computing devices may include a telephone 18 and/or a computer 20. The telephone 18 and computer 20 may host a range of communication modes, such as e-mail, fax, voice call, texting and tweeting, for example. As described herein, the system 10 is configured to switch between or add communication modes to help with communicating appointment requests during busy periods for providing services.

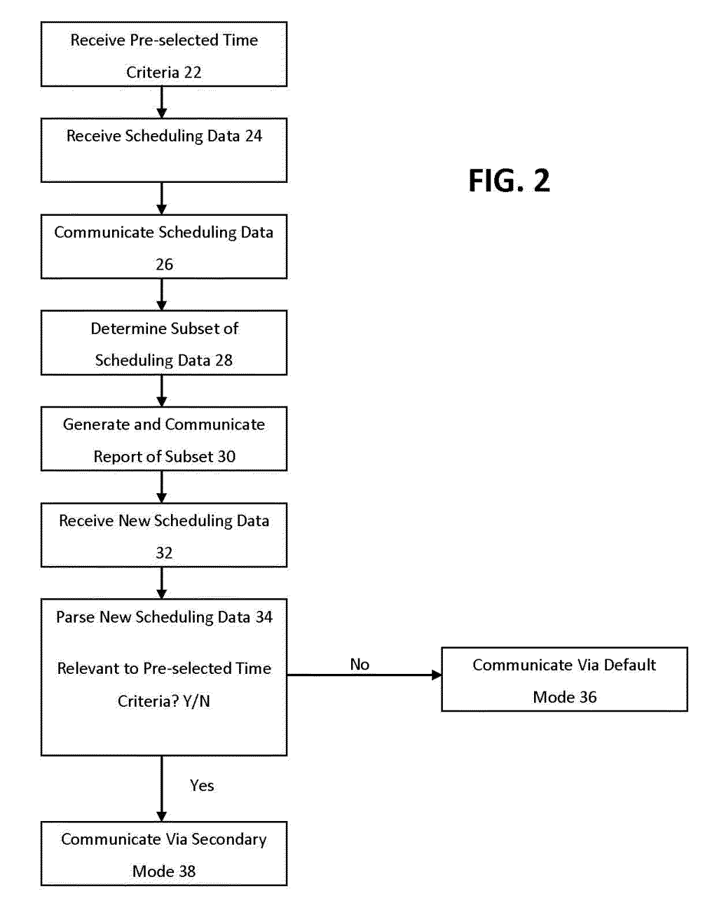

FIG. 2 illustrates an exemplary method 20 of communicating scheduling data to a user using the system shown in FIG. 1, for example, according to one implementation. Pre-selected time criteria from at least one user 16 are received at Step 22. Also, scheduling data for a plurality of appointments is received from prospective clients 14 at Step 24. The scheduling data is communicated to the users 16 via a default communication mode, such as e-mail, in Step 26. A relevant subset of the scheduling data is identified as scheduling data that meets the pre-selected time criteria in Step 28. After identifying the relevant subset of scheduling data, additional or new scheduling data is received in Step 32. In step 34, the new scheduling data is parsed as being within a relevant subset of new scheduling data or a non-relevant subset of new scheduling data. The relevant subset of new scheduling data includes new scheduling data that meets the pre-selected time criteria, and the non-relevant subset of new scheduling data includes new scheduling data that does not meet the pre-selected time criteria. The relevant subset of new scheduling data is communicated to the user using a second communication mode at Step 38. The second communication mode, such as a telephone call, fax or text, is different than the default communication mode, such as e-mail, so as to be more easily handled by the user during the time block defined by the pre-selected time criteria.

The method may also include communicating the non-relevant subset of the new scheduling data to the user using a default communication mode in Step 36. In this implementation, the non-relevant subset of new scheduling data is communicated only by the default communication mode, leaving the second communication mode open for only relevant data. In addition, the method may include generating and communicating a report of the relevant subset of scheduling data at Step 30 prior to receiving the new scheduling data at Step 32.

The pre-selected time criteria may include a time block, such as a time window on a particular day(s) of the week, for example. The relevant subset of the new scheduling data may include appointments received during the time block that are also set to occur during the time block. For example, if scheduling data associated with a new appointment request includes a time of 12:00 pm on Monday and is received at 11:35 a.m. on Monday and the time block of the pre-selected time criteria is 11:30 a.m. to 1:30 p.m. on Mondays, the system 10 identifies this appointment request as meeting the pre-selected time criteria and being within the relevant subset of new scheduling data. The scheduling data associated with the appointment request is communicated via the second communication mode.

In addition, in certain implementations, the pre-selected time criteria may include the time block and a lead time prior to a start time of the time block. The lead time may be the time at which the system 10 is configured for generating and communicating the report to the user that includes scheduling data associated with appointments set to occur within the upcoming time block according to one implementation. For example, if the time block is 11:30 a.m. to 1:30 p.m. on weekdays and the lead time is 60 minutes prior to the start time of the time block (or 10:30 a.m.) and a reservation request for 11:30 a.m. on Monday is received at 11:00 a.m. on Monday, the scheduling data associated with the reservation request is communicated via the second communication mode. However, if the reservation request is for 11:15 a.m. on Monday or for 11:30 a.m. on Tuesday (which are not within the upcoming time block) and the request is received at 11:00 a.m. on Monday (which is after the lead time), the scheduling data associated with the reservation request is communicated via the default communication mode.

The non-relevant subset of new scheduling data may include appointments that do not meet the pre-selected time criteria. For example, if the pre-selected time criteria include a time block, appointments that fall outside the time block are identified as being in the non-relevant subset of new scheduling data. If the pre-selected time criteria also include a lead time associated with the upcoming time block, appointments that are received outside of the lead time and time block are identified as being in the non-relevant subset of new scheduling data. For example, if a new appointment request includes a time of 12:00 p.m. on Tuesday and is received at 11:35 a.m. on Monday and the pre-selected time criteria is 11:30 a.m. to 1:30 p.m. on weekdays, the system 10 identifies this appointment request as being non-relevant to the pre-selected time criteria and communicates the appointment request via the default communication mode.

Notably, other criteria could be applied for a multi-leveled parsing that corresponds with various modes of communication tuned to the needs of the recipient, the characteristics of the communication (level of urgency), and the particular nature of the business for which the appointments are being made. Cancellations, for example, could be prioritized to be communicated via an alternative communication mode, such as a text message or a phone call (assuming these are not the default communication mode), since they immediately impact currently available appointments.

In certain implementations, the appointments may be reservations, and the time block may be a discrete shift time relevant to the user. For example, the discrete shift time may be a meal time at a restaurant or emergency business hours in a doctor's office. The second communication mode may be selected such that it is easier for the user to receive the communication about the reservation via the second communication mode during the discrete shift time. For a restaurant, this may be a telephone call, and for a doctor's office, it may be an e-mail, for example. In contrast, the default communication mode may be more difficult for the user to receive during the discrete shift time. The second communication mode may be one that is generally more urgent to garner additional attention because the information has a more immediate impact.

The system may also include a permission gateway related to the second mode of communication that is configured for receiving feedback from the user. For example, the permission gateway may receive feedback from the user and permit communication of the relevant subset to the user. For example, the second communication mode may be a telephone call. During the call, the system electronically presents to the user the option to receive the new scheduling data, and in response to receiving the keystroke from the user indicating that the user wants to accept the communication, the system communicates the relevant subset of new scheduling data. The system may also receive a keystroke from the user that indicates that the user does not want to accept the communication at that time.

The relevant subset of the new scheduling data may include, for example, a change to one of the appointments, a cancellation of one of the appointments, or a new appointment.

Although various implementations of the invention are described below primarily with reference to restaurant reservation handling and communication, these implementations or others may also be employed in other service industries. For example, the handling and communication of doctor's reservations around business hours (i.e., the pre-selected time period) and non-business hours. Also, implementations may include scheduling service work for cable, car repair, educational seminars, etc., or any other service business that wants varied types of communications based on periods where optimal communication modes may switch or vary.

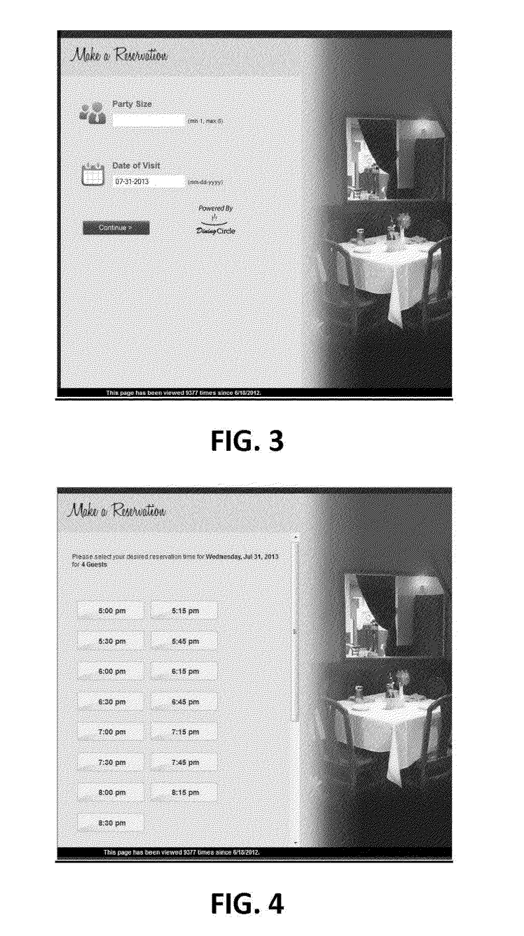

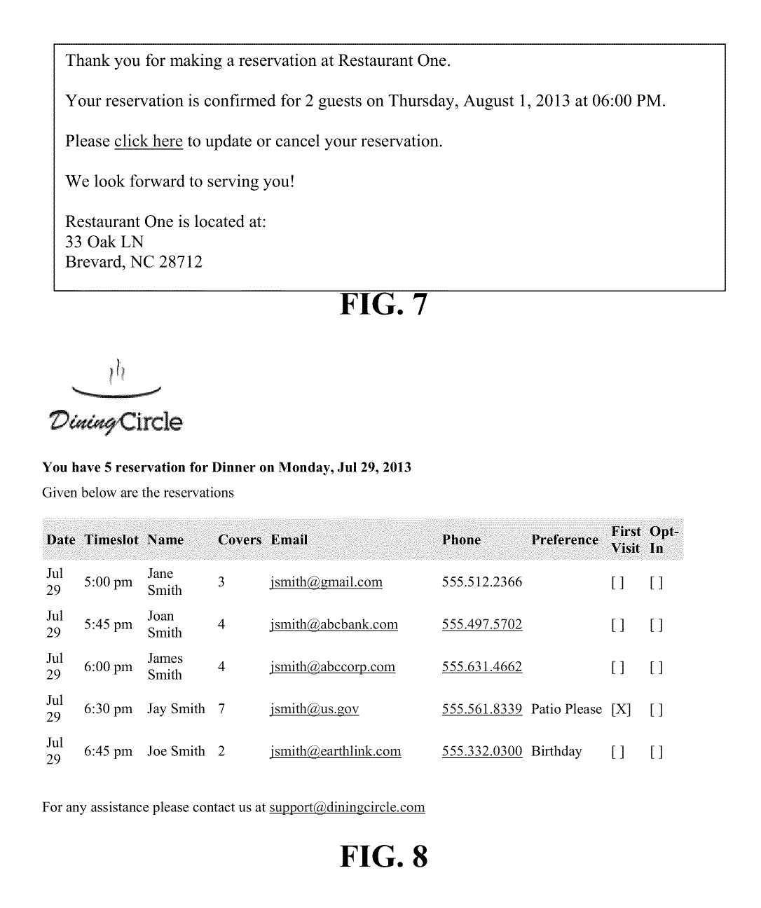

For example, FIGS. 3-9 illustrate various exemplary screen shots that may be generated and communicated by the system 10 to a restaurant for assisting the restaurant with reservations. For example, FIGS. 3-5 illustrate exemplary graphical user interfaces generated by the system for receiving a reservation request from a diner for a restaurant, and FIG. 7 illustrates an exemplary email generated and communicated by the system to the diner confirming the reservation request. FIG. 6 illustrates an exemplary email and FIG. 7 illustrates an exemplary report that are generated and communicated by the system 10 for communicating reservation requests to the restaurant.

In particular, the diner may use the graphical user interfaces shown in FIGS. 3-5 to make a reservation for the restaurant using the restaurant's website or a third-party website that receives reservation requests. FIG. 3 requests for the diner to enter a party size (e.g., between 1 to 8 guests) and the date of the visit (e.g., either through entry of the digits of the date itself or through a calendar dropdown menu). Once entered, the diner hits the “continue” button, and the system 10 displays the graphical user interface shown in FIG. 4.

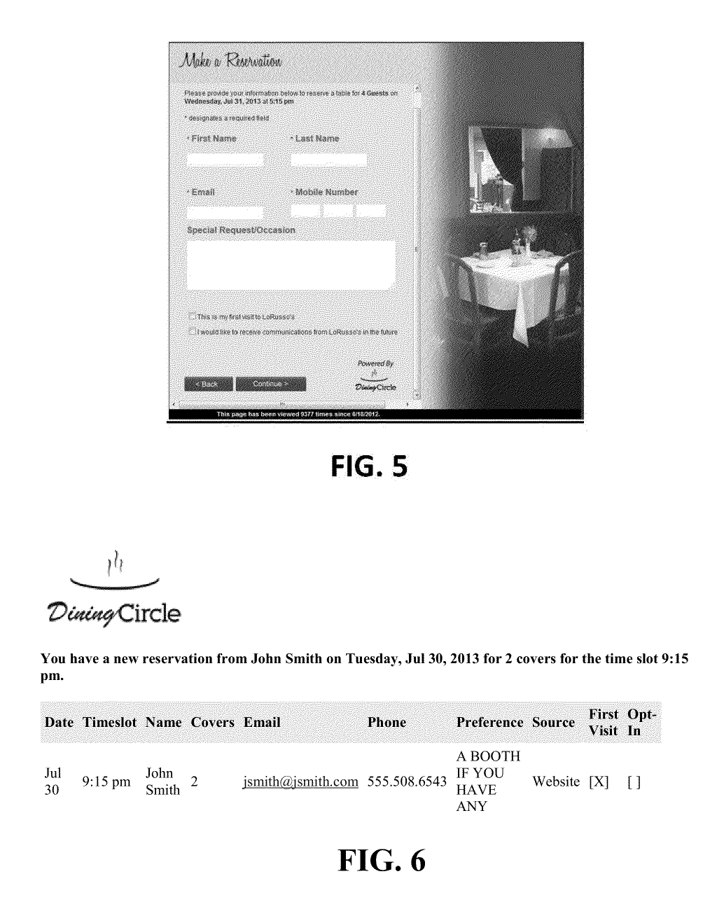

FIG. 4 illustrates a graphical user interface for displaying available seating times based on the date and number of guests requested and receiving a selection from the diner of the requested seating time from the available seating times. The diner may select the appropriate reservation time to advance to the screen of FIG. 5. Alternatively, the diner may also select a “continue” button (not shown) to advance to the next screen.

FIG. 5 illustrates a graphical user interface for receiving additional diner information, including first name, last name, e-mail, phone number and other special requests (e.g., anniversary, birthday, vegan, widow seat). FIG. 5 also displays check boxes for receiving a selection from the diner of whether the diner is a first time diner at the restaurant and whether they would like to receive future e-mail communications from the restaurant.

Generally in one implementation, from the diner's perspective, the diner accesses the system 10 to make a reservation and receives a confirmation of the diner's request, but how the input from the diner is handled by the system 10 is not known to the diner, even when a communication mode switch occurs. For example, FIG. 7 illustrates an exemplary e-mail confirmation of the reservation sent to the diner that made the reservation. The confirmation may also be by other communications modes, such as text, fax or telephone call.

In certain implementations, the confirmation may be customized by the restaurant to include directions, parking instructions, coupons, etc. The confirmation may also include a link for the diner to cancel or make changes to their reservation. The day after the diner shows up for the reservation, the system 10 may e-mail the diner with a customized (e.g., by the restaurant) survey with questions about the diner's experience.

FIG. 6 illustrates an exemplary e-mail communication of a reservation request generated and communicated by the system 10 to the restaurant. In an implementation in which email is the default mode of communication for the restaurant, this email may correspond with step 26 of FIG. 2, communicating scheduling data, for example.

FIG. 8 illustrates an exemplary shift report containing all of the reservations made for a relevant time block that represents a dinner shift for the restaurant. This report, for example, may correspond with step 30 of FIG. 2 of generating and communicating a report of a subset of appointment data, for example.

Communication of appointment requests need not be limited to a website, but could also be received from mobile-friendly sites, an i-frame within the restaurant's own website, or through a FACEBOOK page or other social media outlet associated with the restaurant. Bookings may also be received via a special event-related website, such as a website with consolidated bookings for several restaurants during restaurant week, sporting event(s), etc.

From the perspective of the restaurant, default operation generally includes one of two options according to certain implementations. For more technically savvy restaurants, the restaurant may access the system 10 over an electronic communication network 12 via a web-enabled computing device (e.g., an iPad, tablet computer, smart phone, etc.), according to one implementation. All reservations received directly by the restaurant (e.g., via telephone and from walk-in customers) are entered into an interface of the system 10 displayed on the web-enabled computing device. Reservations made by diners online are received directly by the system 10 and are viewable by the restaurant via the web-enabled computing device. In this implementation, the system 10 stores the correct status of all reservations and changes at any time.

For restaurants that are less technically savvy, the restaurant may use pen and paper to record reservations that are received directly by the restaurant (e.g., via telephone or from walk-in customers). Online reservations received by the system 10 are electronically communicated to the restaurant via an electronic communication method such as email, phone call, text, or facsimile. The electronic communication may be directed to one or more designated restaurant workers or staff. Typically, the paper-based reservation system (e.g., a book) is updated by one or more restaurant workers based on these communications.

For the paper-based system, the restaurant can control the online bookings through an administrative panel, which may include a user interface generated by the system 10 for receiving input from the restaurant about its reservation parameters. For example, the user interface may include a graphical user interface that is displayable on a computing device or a telephone interface for receiving input from the user via a telephone. For example, the restaurant can define and control its availability, such as by limiting hours, closing on holidays, etc. They may, for example, be open for lunch 5 days a week from 11 am to 2 pm and dinner 6 days a week from 5 pm to 11 pm. The administrative panel may also receive the pre-selected time criteria, such as described in step 22 of FIG. 2. For paper-based systems, the restaurant can use this administrative panel to easily dynamically reduce or increase the number of reservation slots available for online booking based on the amount of reservations the restaurant is receiving via phone and face-to-face or based on other factors (e.g., available staffing). For example, if the restaurant receives too many reservations via phone/face-to-face, it can easily reduce the reservation time slots presented by the system online to potential diners for a particular time/day. Conversely, if the online reservations are active but phone/face-to-face reservations are slow, it can increase the number of reservation time slots via the administrative panel of the system 10.

The system 10 may also be configured for generating a communication (which may be delivered via the default or second communication modes) to the restaurant in response to all online reservation slots being filled or meeting certain threshold. The restaurant may use this information to adjust capacities by checking non-electronic bookings or bringing in an extra worker.

Generally, step 26 of FIG. 2 of communicating scheduling data according to this implementation is real-time, i.e., fairly contemporaneous with the time the reservation is made. For example, if the reservation is made at 2 a.m., the e-mail or other default communication is made at 2 a.m. The restaurant, however, may select a preference for communications to be held until certain preferred days and/or times.

As described above, step 30 of FIG. 2 of generating and communicating a report of a subset of the scheduling data may include generating and communicating a shift report or summary for the restaurant for an upcoming shift. For restaurants, the shift summary may be provided prior to or at the beginning of each shift, based on a lead time. The lead time may be preselected by the restaurant to be 0, 30, 60 or 90 minutes before the shift, for example. Shifts can be determined from the blocks of time availability entered through the administrative panel. The system 10 may receive information defining the standard daily restaurant shifts via the administrative panel, such as when the shifts start and how soon before the shifts does the restaurant want the summary. For example, if the restaurant is opening for dinner at 5 p.m. and requesting a 60 minute notice option, the shift report is communicated at 4 p.m. The shift summary is most likely to be communicated by the default communication mode, such as by e-mail, according to certain implementations.

Step 30 of FIG. 2 of generating and communicating the shift summary may trigger step 34 of parsing the new scheduling data received in step 32. The parsing step could also be triggered by the beginning of the shift. The system analyzes new reservation requests based on the date and time requested for the reservation and the time at which the reservation request is received. Reservations falling in the date/time range of the upcoming shift defined by the shift report and that are received within the lead time specified for the shift report are communicated via a second communication mode in step 38.

The second communication mode is different from the default communication mode. For example, if the default communication mode is email, the second communication mode may include a phone call or text. The new reservations falling in the date/time range of the upcoming shift may also additionally be communicated by the default communication mode. For example, an e-mail may be sent with each new reservation/change/cancellation in reservation plus a telephone call or other second communication mode. New reservations falling outside the shift time block continue to be communicated via the default communication mode, such as shown in step 36 of FIG. 2.

The additional and/or switch in communication mode for new reservation information ensures that the restaurant does not miss an urgent or important message in the upcoming or current shift. This additional communication is especially useful for service providers that track appointments or reservations using an offline system, such as an isolated computer or paper, because each appointment or reservation may have to be handled at least semi-manually. Non-automatic (manual) participation in updating the reservation calendar is difficult to perform during busy times or with other business-dependent distractions.

The system may be configured to provide additional functionality that facilitates the communication of the appointment information when communicating via the second communication mode. For example, the additional functionality may include a gateway option that requests input from the user prior to communicating the appointment information. For example, in the restaurant implementation, the system places a phone call to a designated restaurant staff person to deliver the new reservation information. The messaging system may be equipped, or configured, to provide the gateway option to the busy staff person to control the timing of receipt of the new, relevant reservation information. For example, the message may say: “This is DiningCircle calling with a [new] reservation [change/update] (as applicable). Please press #1 when ready.”

At this point, the recipient has three options: 1) press a certain numerical key (e.g., #1) to hear the message; 2) remain on the line to put the call on hold if the recipient needs a few minutes to do something urgent (e.g., make a change to the reservation system or book, ring a check, seat a table); or 3) hang up. If the recipient puts the call on hold, the system may continue at a certain time interval (e.g., every 15 seconds) to say “press #1 when ready to hear the message”. If the recipient hangs up without providing a response, the system may automatically call back in a certain time period (e.g., 10 minutes) and continue calling until someone presses #1. The recipient may also merely be reminded by the phone call to check their e-mail (or other default communication receiver) for the new reservation information. Other time periods for reminders and call backs may be submitted to the system by the service provider, depending on the needs of the service provider.

As another option, the system may be configured to receive various reservation slots associated with various key words from the restaurant, such as locations or features. For example, different tables may be associated with a window, a fireplace, or a patio, or designated as kid-friendly or romantic. The diner may see the keywords at the time of booking and select amongst them. Or, the system may be configured to recognize the keywords and allocate the slots accordingly. It could algorithmically note requests for highchairs and display available reservation slots associated with a kid friendly table. Or, the system could search the general comments on the reservation for negatives—“We do not want to sit on the patio.” The system would then avoid offering or filling the undesired slots associated with such characteristics.

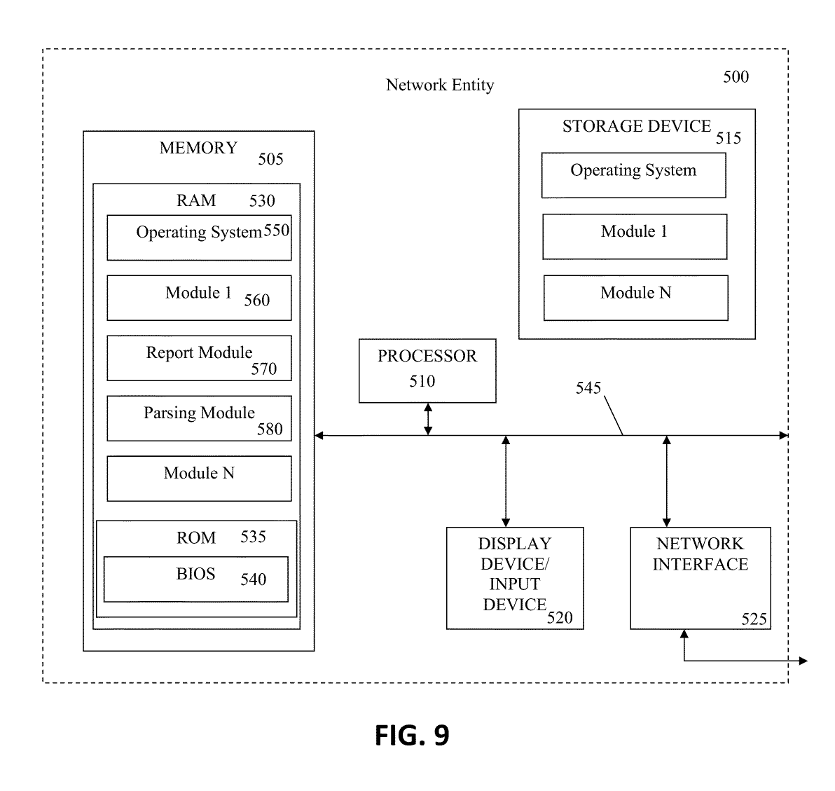

Referring now to FIG. 9, a schematic diagram of a central server 500, or similar network entity, configured to implement an appointment communication system, according to one implementation of the invention, is provided. For example, the server 500 may include the system 10 described above in relation to FIG. 1. As used herein, the designation “central” merely serves to describe the common functionality the server provides for multiple clients or other computing devices and does not require or infer any centralized positioning of the server relative to other computing devices. As may be understood from FIG. 9, in this implementation, the central server 500 may include a processor 510 that communicates with other elements within the central server 500 via a system interface or bus 545. Also included in the central server 500 may be a display device/input device 520 for receiving and displaying data. This display device/input device 520 may be, for example, a keyboard or pointing device that is used in combination with a monitor. The central server 500 may further include memory 505, which may include both read only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface. The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks.

A number of program modules may be stored by the various storage devices and within RAM 530. Such program modules may include an operating system 550 and a plurality of one or more (N) modules 560. The modules 560 may control certain aspects of the operation of the central server 500, with the assistance of the processor 510 and the operating system 550. For example, the modules may perform the functions described above and illustrated by the figures and other materials disclosed herein, such as a report module 570 and a parsing module 580.

The flowchart and block diagrams in the figures illustrate the architecture, functionality, and operation of possible implementations of systems, methods and computer program products according to various implementations of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

What is claimed is:

1. A method of electronically communicating scheduling data to a user, the method comprising:
electronically receiving a pre-selected time criteria from a user;
electronically receiving scheduling data associated with each of a plurality of appointments, the scheduling data associated with each appointment comprising at least one time of day;
electronically communicating the scheduling data to the user using a default communication mode;
identifying a relevant subset of the scheduling data that meets the pre-selected time criteria;
after identifying the relevant subset of the scheduling data, receiving new scheduling data;
parsing the new scheduling data into at least a relevant subset of new scheduling data and non-relevant subset of new scheduling data based on the pre-selected time criteria, the relevant subset of new scheduling data including new scheduling data that meets the pre-selected time criteria, and the non-relevant subset of new scheduling data including new scheduling data that does not meet the pre-selected time criteria; and
electronically communicating the relevant subset of the new scheduling data to the user using a second communication mode, wherein the second communication mode is different from the default communication mode.

2. The method of claim 1, further comprising electronically communicating the non-relevant subset of the new scheduling data to the user using the default communication mode.

3. The method of claim 2, further comprising electronically generating and communicating a report to the user, the report including the relevant subset of the scheduling data.

4. The method of claim 3, wherein the pre-selected time criteria include a time block.

5. The method of claim 4, wherein the pre-selected time criteria include a lead time prior to a start time of the time block.

6. The method of claim 5, wherein the relevant subset of the new scheduling data includes scheduling data associated with appointments occurring within the time block that is received on or after the lead time.

7. The method of claim 4, wherein the relevant subset of the new scheduling data includes new scheduling data associated with appointments occurring within the time block.

8. The method of claim 4, wherein the non-relevant subset of the new scheduling data includes new scheduling data associated with appointments falling outside of the time block.

9. The method of claim 4, wherein the appointments are reservations and wherein the time block is a discrete shift time relevant to the user.

10. The method of claim 9, wherein the default mode of communication is difficult for the user to receive during the discrete shift time and wherein the second communication mode is easier to receive during the discrete shift time.

11. The method of claim 1, further comprising electronically requesting permission input from the user prior to communicating the relevant subset of the new scheduling data to the user, the input being requested and receivable electronically via the second communication mode, and wherein electronically communicating the relevant subset of new scheduling data occurs in response to receiving the permission input.

12. The method of claim 11, wherein the second communication mode is a telephone call and the permission input is a key strike.

13. The method of claim 12, wherein electronically requesting permission input from the user comprises repeating an invitation to select the key strike at regular intervals until the key strike is received or until the user terminates the telephone call without inputting the key strike.

14. The method of claim 13, wherein in response to the user not selecting the key strike prior to terminating the telephone call, electronically calling the user at a later time following the termination.

15. The method of claim 1, wherein the scheduling data comprises an indication of a type of appointment request, the type of appointment request selected from the group consisting of: a change to an existing appointment, a cancellation of an existing appointment, and a new appointment.

16. The method of claim 1, further comprising electronically communicating the relevant subset of the new scheduling data to the user using the default communication mode.

17. A system of communicating scheduling data to a user, the system comprising a computing device that comprises a processor and a memory, the processor being configured for:
electronically receiving a pre-selected time criteria from a user;
electronically receiving scheduling data associated with an appointment, the scheduling data for the appointment being associated with a first time at which the scheduling data is received and comprising a second time at which the appointment is to occur, the second time being subsequent to the first time;
comparing the first time and the second time with the pre-selected time criteria;
in response to the first time or the second time not meeting the pre-selected time criteria, communicating the scheduling data associated with the appointment to the user via the default communication mode; and
in response to the first time and the second time meeting the pre-selected time criteria, communicating the scheduling data associated with the appointment to the user via a second communication mode, wherein the second communication mode is different from the default communication mode.

18. The system of claim 17, wherein the pre-selected time criteria include a time block.

19. The system of claim 18, wherein the pre-selected time criteria include a lead time prior to a start time of the time block.

20. The system of claim 18, wherein the appointment is a reservation and the time block is a discrete shift time relevant to the user.

21. The system of claim 17, wherein in response to the first time and the second time meeting the pre-selected time criteria, the processor is further configured for electronically requesting permission input from the user prior to communicating the scheduling data to the user via the second communication mode, the input being requested and receivable electronically via the second communication mode, and wherein electronically communicating the scheduling data occurs in response to receiving the permission input.

22. The system of claim 17, wherein in response to the first time and the second time meeting the pre-selected time criteria, communicating the scheduling data associated with the appointment to the user via the default communication mode.
